(19) United States
(12) Patent Application Publication
(10) Pub. No.: US 2004/0082370 A1
(43) Pub. Date: Apr. 29, 2004

(54) Method for producing a housing of a mobile communication terminal, housing and mobile communication terminal

(76) Inventors: Andreas Gahl, Muenchen (DE); Edgar Jochheim, Muenchen (DE); Michael Schreiber, Goggenhofen (DE)

Correspondence Address: BELL, BOYD & LLOYD, LLC, P. O. BOX 1135, CHICAGO, IL, 60690-1135, US

(21) Appl. No.: 10/451,343

(22) PCT Filed: Dec. 19, 2001
(86) PCT No.: PCT/DE01/04780

(30) Foreign Application Priority Data
Dec. 20, 2000 (DE) 100 63 696.9

(51) Int. Cl. H04M 1/00

(52) U.S. Cl. 455/575.5; 455/562.1; 455/90.3; 455/550.1

(57) ABSTRACT

A method is provided for producing a housing of a mobile communication terminal, especially of a mobile radio terminal, a cordless telephone or the like, with at least one antenna for transmitting and/or receiving signals that is integral with the housing. The method includes the following steps: A) producing a housing blank from a non-electroconductive material with an antenna zone provided for the antenna; and B) providing the housing blank with an electroconductive antenna material in the antenna zone. A housing for a mobile communication terminal that is produced according to the method is also provided, as is a mobile communication terminal including such a housing.

The invention relates to a method for producing a housing of a mobile communication terminal, especially a mobile radio terminal, a cordless telephone or the like.

When producing a mobile communication terminal, it is necessary to provide a transmitting or/and receiving antenna for transmitting and receiving information. This antenna must be adapted in its geometry to the frequency band in which the mobile communication terminal transmits and receives information. Furthermore, it is necessary that, when producing mobile communication terminals in large numbers, the individual antennas have an identical geometry in each case, to avoid dimensional deviations. The reason for this is that the transmitting and receiving electronics of the mobile radio terminal have to be set to the respective antenna geometry. Production-related deviations from a predetermined antenna geometry consequently require an individual adaptation of the transmitting and receiving electronics in the case of each individual communication terminal, which would constitute an unacceptable effort when producing high numbers.

To satisfy the requirements described above, antenna assemblies which are fitted into the housing during the assembly of the mobile communication terminal are conventionally produced. These may be external helix antennas or rod antennas that can be fixed on the housing, which increase the housing dimensions and detract from the visual appearance of the mobile communication terminal. Furthermore, it is possible for planar antennas to be placed in the housing, so that they cannot be seen by an observer after the assembly of the mobile communication terminal. Such planar antennas, also known as patch antennas, are given the form in the prior art of prefabricated, planar metal bodies which are placed directly into the housing or are fastened on separate antenna bodies and fitted together with the latter in the housing. Such patch antennas require additional installation space in the housing of the mobile communication terminal. The housing must be adapted in its geometry to such patch antennas, which can have the effect of detracting from the external appearance and the ergonomics of the mobile communication terminal.

In addition, structural precautions have to be taken on the housing to ensure a sufficiently great distance between the patch antenna and the ground of the transmitting and receiving electronics of the communication terminal, since only with a sufficiently great distance is it possible to realize an antenna with an adequately large bandwidth.

Against this background, it is an object of the present invention to provide a method of the type referred to at the beginning with which an efficient antenna can be produced in a space-saving way with a reproducible geometry, adapted to the structural design of the housing.

This object is achieved by a method for producing a housing of a mobile communication terminal, especially a mobile radio terminal, a cordless telephone or the like, with at least one antenna for transmitting or/and receiving signals which is integrally formed on the housing, the method according to the invention comprising the steps of:

housing, the method according to the invention comprising the steps of claim 1.

A) producing a housing blank from an electrically nonconducting material with an antenna zone to be taken up by the antenna and

B) providing the housing blank with electrically conducting antenna material in the antenna zone.

According to the invention, firstly a housing blank is produced from an electrically nonconducting material, on which housing blank an antenna zone to be taken up by the antenna is provided. For this antenna zone, it is not necessary, as in the case of conventional planar two-dimensional patch antennas arranged in the interior of the communication terminal housing, for additional installation space to be provided for the antenna. Rather, it is possible—since in step B) the housing blank is integrally provided with electrically conducting antenna material in the antenna zone—to provide on the housing blank a possibly three-dimensional planar zone as the antenna zone, which can then be provided directly with electrically conducting antenna material. The invention has the further advantage that the antenna material is arranged at the greatest possible distance from the transmitting and receiving electronics in the housing, so that good receiving properties can be achieved.

According to the invention, it may be provided in step B that the surface of the housing blank is selectively metallized in the antenna zone provided on the latter. This means that a metal layer can be applied to the housing blank in the antenna zone, which metal layer is then contacted when the transmitting and receiving electronics are fitted and becomes effective as the antenna.

In a development of the invention, it may be provided that the antenna zone is formed by at least one depression or recess which is provided in the housing blank and the geometry of which corresponds to the geometry of the at least one antenna. In this case, the depression may merely have a small depth, so that it cannot be seen when the housing blank is viewed from its exterior visible side. When this recess is provided, it must be closed in step B or thereafter, which will be further discussed in detail later.

On account of the sometimes complicated housing geometry and high numbers of mobile communication terminals, production of the housing blank from plastic, especially by an injection-molding process, is appropriate. In a development of the invention, it may be provided in this connection that steps A and B are performed by a two-component injection-molding process, with an electrically nonconducting plastics material being processed in step A to form the housing blank, as the first component, and a conducting plastics material being injected into the antenna zone in step B, as the second component. In this case, firstly a mold is filled with the first component. A removable core, which ensures that the antenna zone is not filled with the first component, is inserted into this mold. After partial or complete curing of the first component, the removable core is then removed from the mold in such a way that a cavity corresponding to the antenna zone is formed. Then, this cavity corresponding to the antenna zone is filled with the second component. After the curing of the two components, the housing is removed from the mold. The antenna is consequently integrally formed in the housing. A major advantage of this method lies in the high reproducing accuracy with regard to the housing and antenna geometry. Furthermore, with this method it is possible in an easy way to achieve three-dimensional antenna structures, which in high numbers ensure cost-effective and efficient utilization of the installation space available for the antenna.

As an alternative to the two-component injection-molding process described above, in step B it may be provided in a development of the invention that the electrically conducting material is applied to the housing blank by hot stamping. In the case of this production method, in step B the following substeps are performed:

B1) placement of an overdimensioned, planar, electrically conducting material onto the antenna zone,

B2) planar pressing of the electrically conducting material on the surface of the housing blank by means of a die formed in accordance with the geometry of the antenna zone,

B3) local melting of the housing blank material on the surface in contact with the electrically conducting material in the region of the die,

B4) curing of the melted housing blank material and

B5) removal of the electrically conducting material extending beyond the antenna zone.

In step B1, a metal foil material, especially of pure copper or of copper coated with Sn, Pb, Ni, Ag and/or Au, is used for example as the electrically conducting material. This planar electrically conducting material is then pressed with a die, with a geometry corresponding to the antenna zone, completely over the surface area of the antenna zone or merely in certain zones. The die is preferably heatable and is heated during the pressing of the planar electrically conducting material in such a way that the housing blank material locally melts superficially. After that, the melted zone can cure again by active or passive cooling, the planar electrically conducting material becoming attached by adhesion during curing to the cured housing blank material. During or after the curing, the die may be removed. Finally, in step B5, the electrically conducting material extending beyond the antenna zone is removed by subsequent machining, for example by a cutting step. In an advantageous development of the invention, a brittle metal material, which on account of its brittleness can be broken off, torn off or otherwise removed with little mechanical effort in its portion extending beyond the antenna zone after the curing of the melted housing blank material, is used as the planar electrically conducting material.

As a further alternative for step B, it may be provided that the housing blank is provided with electrically conducting material in the antenna zone by laser structuring. In the case of this variant of the invention, step B may comprise the following substeps:

B1) application of an electrically conducting material in the antenna zone and in the zone surrounding the latter and

B2) removal of the electrically conducting material in the zone surrounding the antenna zone by local burning by means of a laser beam.

In the case of this variant of the invention, firstly electrically conducting material is applied in the antenna zone. This may be an electrically conducting lacquer, which is applied to the inner side of the housing blank. Alternatively, the electrically conducting material may also be a metal which is electrodeposited onto the surface of the housing blank. In both cases it may be of advantage if—as already indicated above—a depression in which the applied electrically conducting lacquer or the electro-deposited electrically conducting material predominantly collect is provided in the housing blank. After the electrically conducting material has been applied according to step B1, it can be cured. After that, the electrically conducting material is locally burned by means of a laser beam in the zone surrounding the antenna zone. This variant of the production method ensures exact maintenance of the antenna geometry, since an excess of the electrically conducting material is initially applied to the surface of the housing blank and the antenna contour is subsequently established exactly, if appropriate in a computer-aided manner, with the help of the laser beam.

As an alternative to the variants described above with regard to step B, that is to say two-component injection molding, hot stamping by means of a metal foil material and laser structuring, in the case of a further variant of the method according to the invention it may be provided that step B comprises the substeps of:

B1) placement of a mask onto the housing blank, the mask having an antenna recess of a geometry which corresponds to the geometry of the antenna zone,

B2) application of an electrically conducting material to the mask in the zone of the antenna recess in such a way that the antenna zone of the housing blank is completely covered with applied electrically conducting material and

B3) removal of the mask.

In step B1, a mask adapted to the already produced housing blank is preferably placed onto the latter in a predetermined position. In step B2, as already proposed above for the laser structuring, an electrically conducting lacquer or an electrically conducting material is applied to the housing blank and the mask by electrodeposition. After removal of the mask, only the antenna zone not covered by the mask is provided with the electrically conducting material. It is also possible in the case of this variant of the invention to provide the housing in advance with a depression in which the applied electrically conducting material then collects. It must be ensured, however, that in this case the depression is exactly in line with the antenna recess of the mask.

As a further alternative with regard to the realization of step B, it may be provided according to the invention that step B comprises the substeps of:

B1) placement of a mask onto the housing blank, the mask having an antenna recess of a geometry which corresponds to the geometry of the antenna zone,

B2) application of an exposure-activatable material, especially an electrophoretic photoresist, to the mask in the zone of the antenna recess in such a way that the antenna zone of the housing blank is completely covered with applied exposure-activatable material, the exposure-activatable material being able to be transformed into a conducting state by exposure,

B3) exposure of the applied exposure-activatable material and

B4) removal of the mask.

Instead of electrically conducting lacquer or electrodeposited electrically conducting material, as above, in the case of this embodiment of the invention exposure-activatable material, which can be transformed into a conducting state by the exposure and can be fixed on the housing blank, is applied to the housing blank. The fixing may take place after one of steps B2, B3 or B4. Fixing before removal of the mask is recommendable, however, since the geometry of the antenna could be changed or destroyed when the mask is removed by the mechanical effects which it necessarily has to undergo for this.

The invention also relates to a housing for a mobile communication terminal, especially a mobile radio terminal, a cordless telephone or the like, with at least one antenna for transmitting or/and receiving signals which is integrally formed on the housing, the housing being produced by the method of the type described above.

In addition, the invention relates to a mobile communication terminal, especially a mobile radio terminal, a cordless telephone or the like, with a housing produced according to the invention and at least one antenna for transmitting or/and receiving signals which is integrally formed on the housing, the housing being produced by the method of the type described above.

Exemplary embodiments of the present invention are described below on the basis of the accompanying drawings, in which:

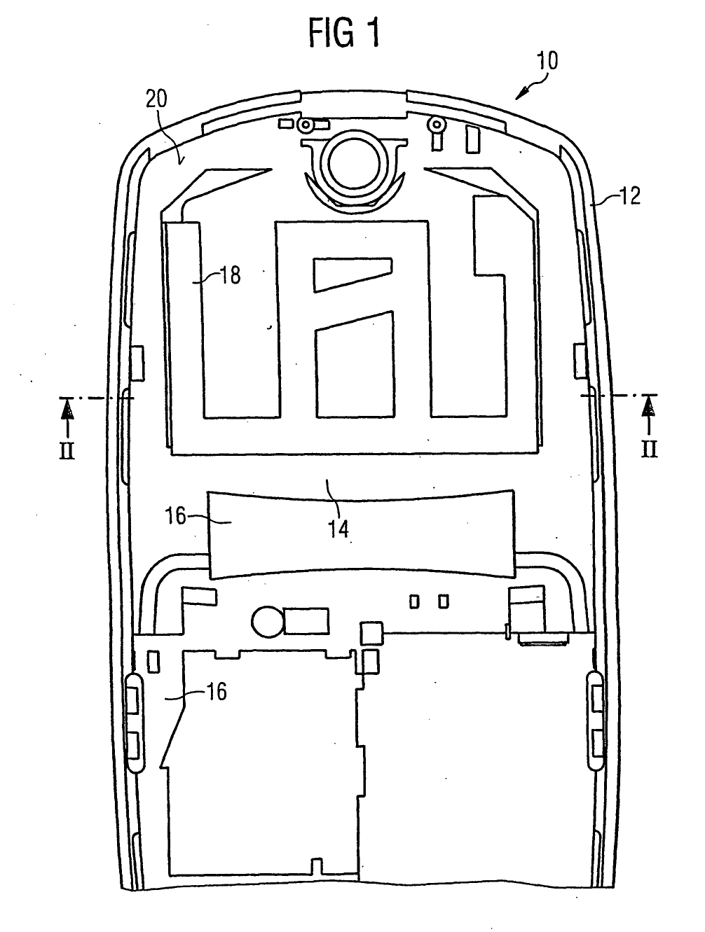

FIG. 1 shows a photographic partial plan view of a housing according to the invention of a mobile radio terminal;

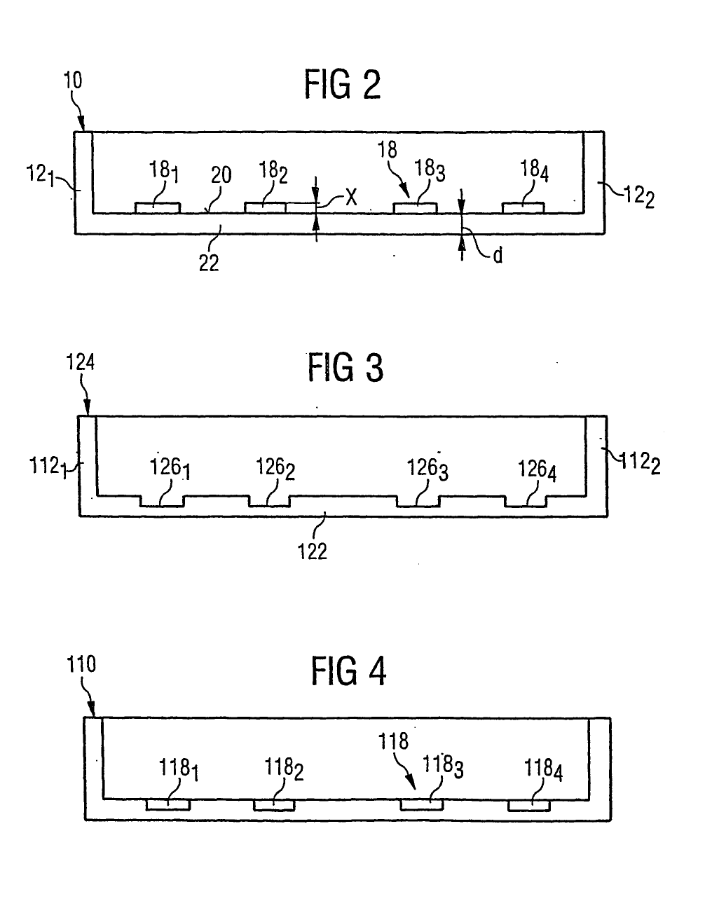

FIG. 2 shows a section along II-II of an embodiment of the invention;

FIG. 3 shows a sectional representation corresponding to FIG. 2 of a housing blank with recesses provided in the antenna zone and

FIG. 4 shows a sectional representation corresponding to FIG. 3 with electrically conducting antenna material.

In FIG. 1, a housing shell according to the invention is generally designated by 10. This comprises a border 12 and an inner zone 14 surrounded by the border 12. Fitted in the inner zone 14 are components 16 of the transmitting and receiving electronics; in the upper region in FIG. 1, a transmitting and receiving antenna 18 is also provided. This transmitting and receiving antenna 18 is formed by a conducting layer applied to the inner surface 20 of the housing shell 10. For further description of the transmitting and receiving antenna 18 and of the possible methods of attaching the transmitting and receiving antenna to the housing shell 10, FIGS. 2 to 4 are discussed. FIG. 2 shows a sectional representation of the housing shell 10, taken in section along the sectional line II-II, as represented in FIG. 1. As shown in FIG. 2, the housing shell 10 comprises two border portions 12₁ and 12₂ and also a bottom portion 22. As already described with respect to FIG. 1, integrally attached on the inner surface 20 is the transmitting and receiving antenna 18, with subzones 18₁, 18₂, 18₃ and 18₄ of the transmitting and receiving antenna 18 being represented in section. These have been applied to the inner surface 20 of the bottom zone 22 of the housing shell 10 in such a way that they protrude from the latter by a small height x. It should be pointed out that the height x is not represented to scale in FIG. 2 but is exaggerated to illustrate more clearly the essence of the invention. In fact, the height x lies in the range of several μm in the case of electrodeposited surfaces, up to 150 μm in the case of metal foils, whereas the material thickness d of the housing shell 12 lies in the range of several mm.

An electrically conducting material is used for the transmitting and receiving antenna 18, for example an electrically conducting lacquer, a metal, or an electrically conducting plastic, which is integrally provided on the bottom zone 22 during the production of the housing shell 10. This may take place, for example, by the inner surface 20 of the bottom zone 22 being provided with a metal layer by electrodeposition, which metal layer already has the contour of the transmitting and receiving antenna 18 or which metal layer is subsequently given the contour of the transmitting and receiving antenna 18 by secondary finishing, as represented in plan view in FIG. 1.

FIGS. 3 and 4 show two states in the procedure based on the method according to the invention. To avoid repetition, the same reference numerals as in FIGS. 1 and 2 are used hereafter, but supplemented by the number 100.

FIG. 3 shows a housing blank 124 with border portions 112₁ and 112₂ and also the bottom zone 122. In the bottom zone 122, cross-sectionally rectangular depressions 126₁, 126₂, 126₃ and 126₄ have been made. Such a housing blank 124 can be produced, for example, by an injection-molding process, in which a non-conducting plastics material is injected into a mold corresponding to the housing blank 124, with mold zones corresponding to the depressions 126₁ to 126₄.

The housing blank 124 according to FIG. 3 is then subjected to a further production step, in which the depressions 126₁ to 126₄ are filled with an electrically conducting material, in order to form the antenna 118 with its antenna zones 118₁, 118₂, 118₃ and 118₄, which can be seen in FIG. 4.

This may take place, for example, by an electrically conducting lacquer being filled into the depressions 126₁ to 126₄ or by a metal being electrodeposited in these depressions.

After providing the housing blank 124 with the antenna portions 118₁ to 118₄ for forming the antenna 118, the housing shell 110 is obtained, and can then be further processed during the final assembly of a mobile radio terminal. In this final assembly, it is merely necessary to connect the antenna 118, which is integrally formed on the housing shell 110, to the transmitting and receiving electronics by corresponding contacts.

The invention described above shows a way in which a planar patch antenna can be integrally attached to a housing part in the case of a mobile communication terminal and, as a result, advantages can be achieved in the production of mobile communication terminals in large numbers. With the method described above, patch antennas of a three-dimensional structure can be formed in a conventional housing with effective space utilization. As a result, structural measures which were necessary for accommodating conventional patch antennas formed as separate parts, and additional assembly steps are avoided. With the method described above, housing shells with patch antennas can be produced in high numbers with sufficiently good reproducing accuracy with regard to the antenna geometry to be maintained.

1. A method for producing a housing (10; 110) of a mobile communication terminal, especially a mobile mobile radio terminal, a cordless telephone or the like, with at least one antenna (18; 118) for transmitting or/and receiving signals which is integrally formed on the housing (10; 110), the method comprising the steps of:
A) producing a housing blank (124) from an electrically nonconducting material with an antenna zone (126₁, 126₂, 126₃, 126₄) to be taken up by the antenna (18; 118) and
B) providing the housing blank (124) with electrically conducting antenna material (118₁, 118₂, 118₃, 118₄) in the antenna zone.

2. The method as claimed in claim 1, characterized in that in step B the surface (20) of the housing blank is selectively metallized in the antenna zone provided on the latter.

3. The method as claimed in claim 1 or 2, characterized in that the antenna zone is formed by at least one depression (126₁, 126₂, 126₃, 126₄) or recess which is provided in the housing blank (124) and the geometry of which corresponds to the geometry of the at least one antenna (118).

4. The method as claimed in one of the preceding claims, characterized in that the housing blank (124) is produced from plastic, especially by injection molding.

5. The method as claimed in one of the preceding claims, characterized plastics material being processed in step A to form the housing blank, as the first component, in that steps A and B are performed by a two-component injection-molding process, with an electrically nonconducting plastics material being processed in step A to form the housing blank, as the first component, and a conducting plastics material being applied in the antenna zone in step B, as the second component.

6. The method as claimed in one of claims 1 to 4, characterized in that in step B the electrically conducting material (118₁, 118₂, 118₃, 118₄) is applied to the housing blank by hot stamping.

7. The method as claimed in claim 6, characterized in that step B comprises the substeps of:
B1) placement of an overdimensioned, planar, electrically conducting material onto the antenna zone,
B2) planar pressing of the electrically conducting material on the surface of the housing blank by means of a die formed in accordance with the geometry of the antenna zone,
B3) local melting of the housing blank material on the surface in contact with the electrically conducting material in the region of the die,
B4) curing of the melted housing blank material and
B5) removal of the electrically conducting material extending beyond the antenna zone.

8. The method as claimed in claim 6 or 7, characterized in that the electrically conducting material in step B1 is a metal foil material, especially of pure copper or of copper coated with Sn, Pb, Ni, Ag and/or Au.

9. The method as claimed in one of claims 1 to 4, characterized in that in step B the housing blank is provided with electrically conducting material in the antenna zone by laser structuring.

10. The method as claimed in claim 9, characterized in that step B comprises the substeps of:
B1) application of an electrically conducting material in the antenna zone in the zone surrounding the latter and
B2) removal of the electrically conducting material in the zone surrounding the antenna zone by local burning by means of a laser beam.

11. The method as claimed in claim 10, characterized in that in step B1) an electrically conducting lacquer is applied in the antenna zone.

12. The method as claimed in claim 10, characterized in that in step B1) the electrically conducting material, especially a metal, is electrodeposited.

13. The method as claimed in one of claims 1 to 4, characterized in that step B) comprises the substeps of:
B1) placement of a mask onto the housing blank, the mask having an antenna recess of a geometry which corresponds to the geometry of the antenna zone,
B2) application of an electrically conducting material to the mask in the zone of the antenna recess in such a way that the antenna zone of the housing blank is completely covered with applied electrically conducting material and
B3) removal of the mask.

14. The method as claimed in claim 1, characterized in that in step B2) an electrically conducting lacquer is applied to the mask.

15. The method as claimed in claim 11, characterized in that in step B2) the electrically conducting material, especially metal, is electrodeposited.

16. The method as claimed in one of claims 1 to 4, characterized in that in step B2) the electrically conducting material, especially metal, is electrodeposited.

17. The method as claimed in one of claims 1 to 4, characterized in that step B) comprises the substeps of:
B1) placement of a mask onto the housing blank, the mask having an antenna recess of a geometry which corresponds to the geometry of the antenna zone,
B2) application of an exposure-activatable material, especially an electrophoretic photoresist, to the mask in the zone of the antenna recess in such a way that the antenna zone of the housing blank is completely covered with applied exposure-activatable material, the exposure-activatable material being able to be transformed into a conducting state by exposure,
B3) exposure of the applied material and
B4) removal of the mask.

18. The method as claimed in claim 16, characterized in that the applied material on the housing blank is fixed after one of the steps B2), B3) or B4).

19. A housing (10; 110) for a mobile communication terminal, especially a mobile radio terminal, a cordless telephone or the like, with at least one antenna (18; 118) for transmitting or/and receiving signals which is integrally formed on the housing (10; 110), the housing (10; 110) being produced by the method as claimed in one of the preceding claims.

20. A mobile communication terminal, especially a mobile radio terminal, cordless telephone or the like, with a housing (10; 110) and at least one antenna (18; 118) for transmitting or/and receiving signals which is integrally formed on the housing, the housing (10; 110) being produced by the method as claimed in one of claims 1 to 17.
